(19) United States
(12) Patent Application Publication
(10) Pub. No.: US 2023/0139422 A1
(43) Pub. Date: May 4, 2023

(54) POLYOL AND FOAM MADE THEREFROM

(71) Applicant: Dow Global Technologies LLC, Midland, MI (US)

(72) Inventors: Weijun Zhou, Sugarland, TX (US); William J. Harris, Lake Jackson, TX (US)

(21) Appl. No.: 17/995,894

(22) PCT Filed: Jun. 24, 2021
(86) PCT No.: PCT/US2021/038854

§ 371 Date: Oct. 10, 2022

Related U.S. Application Data
(60) Provisional application No. 63/044,304, filed on Jun. 25, 2020.

(51) Int. Cl. C08G 18/32; C08G 18/42; C08G 18/08; C08G 18/48; C08G 18/12; C08G 63/199

(52) U.S. Cl. CPC C08G 18/3212; C08G 18/4213; C08G 18/14; C08G 18/4833; C08G 18/12; C08G 63/199; C08G 2101/00

(57) ABSTRACT

Embodiments relate to a liquid aromatic polyester polyol composition for preparing a polyurethane foam product including at least one polyalicyclic structure, wherein the aromatic polyester polyol composition is a clear liquid at room temperature, the viscosity of the aromatic polyester polyol composition, at room temperature and at a shear rate of 10 sec-1, is no greater than 100 Pa-s; and the OH number of the aromatic polyester polyol composition is in the range of from 100 mg KOH/g to 500 mg KOH/g; and a process for preparing the above liquid aromatic polyester polyol composition; an isocyanate-reactive composition and a foam-forming composition comprising the liquid aromatic polyester polyol.

### FIELD

Embodiments relate to a polyol composition useful for preparing polyurethane products; and more specifically, to an aromatic polyester polyol composition for preparing a polyurethane or polyisocyanurate foam product exhibiting an enhanced thermal insulation performance property.

### INTRODUCTION

Polyurethane foams continue to be the choice of materials for many applications requiring thermal insulation performance and light weight. Some of the applications for polyurethane insulation foams include, for example, building and construction, appliances, refrigerated transport, and the like. With the growth of global consumption of energy, there is a strong desire by end users of foam products for a product with better thermal insulation performance and that is easy to process and fabricate. In addition, as strict energy efficiency regulations are promulgated, the industry is searching for a foam product with better thermal insulation performance to meet such regulations. Various attempts have been made to improve thermal insulation performance of polyurethane foams over years. Typically, a polyurethane foam product is prepared by reacting an isocyanate component with an isocyanate-reactive component in the presence of a blowing agent and various other foaming additives. Thermal insulation performance of a polymeric foam is generally considered to be influenced by three components: (1) the type and amount of blowing agent, (2) thermal conductivity of the solid polymer, and (3) foam cell size. However, most of the prior efforts to improve insulation performance of foams is focused on the use and/or optimization of various additives such as surfactants, catalysts, or nucleating additives to make foams with a smaller cell size, which in turn, lowers thermal conductivity. It would be desirous to prepare a foam product with enhanced thermal insulation performance without depending exclusively on additive optimization.

### SUMMARY

Although various structures of polyester polyols are used for making polyurethane and polyisocyanurate foams, most of the known structures aim at addressing fire performance properties and general foam fabrication processes. However, it is difficult to improve thermal insulation performance of polyurethane and polyisocyanurate foams by varying the type and amount of polyols in the foam production. Surprisingly, it has been discovered that a novel modified liquid aromatic polyester polyol comprising a polyalicyclic ring structure of the present invention is suitable for use in preparing a polyisocyanurate (PIR) rigid foam or a polyurethane (PUR) rigid foam (herein together referred to as “PU foam”) exhibiting an enhanced thermal insulation performance compared to conventional aromatic polyester polyols. Furthermore, the novel aromatic polyester polyol exhibits excellent compatibility with various hydrocarbon blowing agents such as cyclopentane, n-pentane, isopentane, and the like, resulting in foams which are readily processable.

In addition to providing an improved thermal insulation performance, the novel aromatic polyester polyol used in the production of a foam product provides a foam product with excellent physical properties such as dimensional stability, compressive strength, density, among other properties, to meet the use requirements for a specific insulation application. Accordingly, the novel aromatic polyester polyol can be used in production of polymeric foams to achieve best in class insulation performance such as for example, for insulated metal panel, polyiso board, appliances, and discontinuous panel applications.

One embodiment relates to a novel liquid aromatic polyester polyol comprising at least one polyalicyclic structure that is surprisingly effective at improving thermal insulation performance when used to make PU foams. The liquid aromatic polyester polyol composition includes at least one polyalicyclic structure of the following general chemical Structure (I):

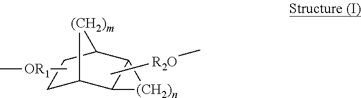

wherein m is an integer number equal to 1 or 2; n is an integer number equal to 0, 1, 2, 3, or 4; R₁ and R₂ are each independently a divalent hydrocarbon group selected from 1 to 6 carbon atoms; and wherein, when n≥1, R₂ is bonded to the ring with (CH₂)ₙ.

In addition, the above novel aromatic polyester polyol, which exists as a clear liquid at room temperature (e.g., 20° C. to 26° C.), is further characterized by having the following properties: (1) a viscosity of ≤100 Pa-s at a shear rate of 10 sec⁻¹ and at room temperature; and (2) an OH number in the range of from 100 mg KOH/g to 500 mg KOH/g.

Another embodiment includes a process of preparing the above liquid aromatic polyester polyol wherein the aromatic polyester polyol is the reaction product of at least one aromatic dicarboxylic acid and/or one aromatic dicarboxylic anhydride and/or one aromatic tricarboxylic acid and/or an aromatic tricarboxylic anhydride and/or an aromatic carboxylic acid source with at least one polyhydric alcohol having a polyalicyclic ring structure.

Still another embodiment includes a novel isocyanate-reactive composition comprising the above aromatic polyester polyol; wherein the isocyanate-reactive composition can be reacted with an isocyanate component to make PU foam with improved thermal insulation performance. In this embodiment, the isocyanate-reactive composition including the novel aromatic polyester polyol described above, comprises at least 10 parts (pts) of the above novel aromatic polyester polyol of the present invention, based on the total amount of polyols in the isocyanate-reactive composition equal to 100 pts.

Yet another embodiment includes a foam-forming composition, including: (a) at least one isocyanate component; (b) at least one isocyanate-reactive component being the above isocyanate-reactive composition; and (c) other optional additional foaming components and/or other optional auxiliary additives.

Even still another embodiment includes a PU foam product prepared using the above foam-forming composition.

### DETAILED DESCRIPTION

The term “liquid” herein means a nearly incompressible fluid that conforms to the shape of its container at room temperature.

Temperatures herein are in degrees Celsius (° C.).

“Room temperature” and/or “ambient temperature” herein means a temperature between 20° C. and 26° C., unless specified otherwise.

“Thermal insulation performance” herein means thermal conductivity, also known as “λ value” or “K-factor”, in units of mW/m-K at a predetermined temperature.

A “polyisocyanate”, “monomeric isocyanate”, or “isocyanate-containing material” herein means an isocyanate compound that has more than one isocyanate group. A “polymeric isocyanate” herein means a high molecular weight homologue and/or an isomer of any monomeric isocyanate; and is a subset of a “polyisocyanate”. For instance, polymeric methylene diphenyl isocyanate refers to a high molecular weight homologue and/or an isomer of methylene diphenyl isocyanate; and is a polymeric isocyanate.

A “polyester polyol” herein means a polyol compound having at least one ester linkage.

A “polyalicyclic” herein means a multi-ring system that is an aliphatic which includes fused rings, bridged fused rings, bridged rings, polycyclic rings, and spiro rings.

An “aromatic carboxylic acid source” herein means the ester derivatives and acid halide derivatives of aromatic dicarboxylic acid, aromatic dicarboxylic dianhydride, aromatic tricarboxylic acid, aromatic tricarboxylic anhydride, aromatic tetracarboxylic acid, and aromatic tetracarboxylic anhydride.

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; “≥” means “greater than or equal to”; “@” means “at”; μm=micron(s), g=gram(s); mg=milligram(s); mW/m-K=milliWatt(s) per meter-degree Kelvin; L=liter(s); mL=milliliter(s); g/mL=gram(s) per milliliter; g/L=gram(s) per liter; kg/m³=kilogram(s) per cubic meter; ppm=parts per million by weight; pbw=parts by weight; rpm=revolutions per minute; m=meter(s); mm=millimeter(s); cm=centimeter(s); μm=micrometer(s); min=minute(s); s=second(s); ms=millisecond(s); hr=hour(s); Pa-s=Pascal second(s); mPa-s=milliPascal second(s); g/mol=gram(s) per mole(s); g/eq=gram(s) per equivalent(s); mg KOH/g=milligrams of potassium hydroxide per gram(s); Mₙ=number average molecular weight; M_{w}=weight average molecular weight; pts=part(s) by weight; 1/s or sec⁻¹=reciprocal second(s) [s⁻¹]; ° C.=degree(s) Celsius; mmHg=millimeters of mercury; psig=pounds per square inch; kPa=kilopascal(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

In one broad embodiment, a novel isocyanate-reactive component. The isocyanate-reactive component is a polyol-containing composition that includes the novel liquid aromatic polyester polyol. The liquid aromatic polyester polyol is used in the isocyanate-reactive component to form a reactive foam-forming composition or system with an isocyanate component. Then, the reactive foam-forming composition comprising the isocyanate component and the isocyanate-reactive component containing the liquid aromatic polyester polyol, in turn, can be used to form a foam product.

In an embodiment, the liquid aromatic polyester polyol includes at least one polyalicyclic structure. In another embodiment, the liquid aromatic polyester polyol includes at least one polyalicyclic structure wherein the polyalicyclic structure is fused rings. In still another embodiment, the liquid aromatic polyester polyol includes at least one polyalicyclic structure wherein the polyalicyclic structure contains at least one bridged fused rings structure. In yet another embodiment, the liquid aromatic polyester polyol includes at least one polyalicyclic structure wherein the polyalicyclic structure contains at least one bridged rings structure. In even still another embodiment, the liquid aromatic polyester polyol includes at least one polyalicyclic structure wherein the polyalicyclic structure includes at least one compound having the following general chemical structure as shown in Structure (I):

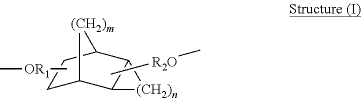

wherein m is an integer number equal to 1 or 2; n is an integer number equal to 0, 1, 2, 3, or 4; R₁ and R₂ are each independently a divalent hydrocarbon group selected from 1 to 6 carbon atoms; and wherein when n≥1, R₂ is bonded to the ring with (CH₂)ₙ; wherein the aromatic polyester polyol is a clear liquid at room temperature; wherein the viscosity of the aromatic polyester polyol composition is ≤100 Pa-s at a shear rate of 10 sec⁻¹ and at room temperature; and wherein the hydroxyl number (OH number) of the aromatic polyester polyol is in the range of from 100 mg KOH/g to 500 mg KOH/g. Structure (I) can also include one or more alkyl substituents on any position of the ring structure where the alkyl substituents are C1 to C6 carbon groups (for example, methyl, ethyl, propyl, isopropyl, and the like).

Exemplary of the polyalicyclic structure having the above Structure (I) can include one or more of the following compounds: (1) where m is 1, n is 3, R₁ is —CH₂— and R₂ is —CH₂— such as tricyclo[5.2.1.0^{2′6}]decanedimethanol; (2) where m is 1, n is 0, R₁ is —CH₂— and R₂ is —CH₂-such as bicyclo[2.2.1]heptane-2,3-dimethanol; and (3) where m is 2, n is 0, R₁ is —CH₂— and R₂ is —CH₂— such as bicyclo[2.2.2]octane-1,4-dimethanol and bicyclo[2.2.2]octane-2,5-dimethanol.

In one embodiment, the liquid aromatic polyester polyols containing the above polyalicyclic Structure (I) can include, for example, a reaction product of:

(i) at least one compound selected from the group consisting of: an aromatic dicarboxylic acid, an aromatic dicarboxylic anhydride, an aromatic tricarboxylic acid, an aromatic tricarboxylic anhydride, an aromatic tetracarboxylic acid, an aromatic tetracarboxylic anhydride, an aromatic carboxylic acid source, and mixtures thereof; wherein the amount of carboxylic acid group and/or carboxylic acid equivalent group that are directly bonded to an aromatic ring structure in component (i) is at least 25 mol %, based on the total moles of carboxylic acid group and/or carboxylic acid equivalent group used in the preparation of the aromatic polyester polyol; and

(ii) at least one polyhydric alcohol; wherein the at least one polyhydric alcohol comprises a polyalicyclic ring structure shown in Structure (I) and/or a diol compound having the following general chemical Structure (II):

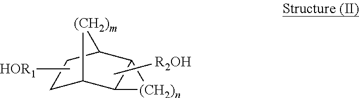

wherein m is an integer number equal to 1 or 2; n is an integer number equal to 0, 1, 2, 3, or 4; R₁ and R₂ are each independently a divalent hydrocarbon group selected from 1 to 6 carbon atoms; and wherein when n≥1, R₂ is bonded to the ring with (CH₂)ₙ; and wherein the amount of the at least one polyhydric alcohol having the polyalicyclic ring of Structure (I) and/or Structure (II) is at least 10 percent based on the total moles of hydroxyl groups of all polyhydric alcohols used in the preparation of the aromatic polyester polyol; wherein the aromatic polyester polyol composition is a clear liquid at room temperature; wherein the viscosity of the aromatic polyester polyol composition is ≤100 Pa-s at a shear rate of 10 sec⁻¹ and at room temperature; and wherein the OH number of the aromatic polyester polyol composition is in the range of from 100 mg KOH/g to 500 mg KOH/g. In another embodiment, Structure (II) also includes one or more alkyl substituents on the ring structures where the alkyl substituents are from C1 to C6 carbon groups.

In an embodiment, suitable aromatic carboxylic acids or anhydrides, component (i), useful for preparing the aromatic polyester polyol may include, for example, at least one aromatic carboxylic acid or anhydride selected from the group consisting of: (1) a dicarboxylic acid or dicarboxylic anhydride containing one aromatic ring; (2) a dicarboxylic acid or carboxylic anhydride containing more than one aromatic ring; (3) a tricarboxylic acid or tricarboxylic anhydride containing one or more aromatic rings; (4) a tetracarboxylic acid or tetracarboxylic anhydride containing one or more aromatic rings; or (5) mixtures thereof.

For example, the first carboxylic acid or anhydride containing one aromatic ring can include one or more of the following compounds: terephthalic acid; isophthalic acid; phthalic acid; phthalic anhydride; 2,5-furandicarboxylic acid; tetrachlorophthalic acid; pyridine dicarboxylic acid and its isomers; and mixtures thereof.

For example, the second carboxylic acid or anhydride containing more than one aromatic ring can include one or more of the following compounds: 2,6-napthalenedicarboxylic acid and its positional isomers; 2,3-napthalenedicarboxylic anhydride; 1,8-naphthalic anhydride; 4,4′-bibenzoic acid and its positional isomers; 4,4′-carbonyldibenzoic acid and its positional isomers; 4,4′-dicarboxydiphenyl ether and its positional isomers; 4,4′-dicarboxydiphenyl sulfone and its positional isomers; and mixtures thereof.

For example, the third carboxylic acid or anhydride containing at least one aromatic ring can include one or more of the following compounds: 1,3,5-benzenetricarboxylic acid; trimellitic acid; trimellitic anhydride; and mixtures thereof.

For example, the fourth carboxylic acid or anhydride containing at least one aromatic ring can include one or more of the following compounds: pyromellitic acid; pyromellitic dianhydride; 4,4′-(hexafluoroisopropylidene)diphthalic anhydride; 3,3′,4,4′-biphenyltetracarboxylic dianhydride; 3,3′,4,4′-benzophenonetetracarboxylic dianhydride; 3,3′,4,4′-diphenylsulfonetetracarboxylic dianhydride; 4,4′-oxydiphthalic anhydride; 4,4′-(isopropylidene)diphthalic anhydride; or mixtures thereof.

One or more of the above-described first, second, third, and forth carboxylic acids or anhydrides can be used to prepare the aromatic polyester polyol. As known to those skilled in the art, a range of derivatives of the aromatic carboxylic acids can be utilized in place of the aromatic carboxylic acids as aromatic carboxylic acid sources to prepare the aromatic polyester polyol. Such derivatives can include, for example but not limited to, alkyl esters such as dimethyl terephthalate, dimethyl isophthalate, dimethyl phthalate, aromatic polyesters like polyethylene terephthalate (PET), recycled polyethylene terephthalate (rPET), polybutylene terephthalate, polyethylene napthalate, aromatic polyester polyols, and the like; polycarboxylic anhydrides; and acid halides such as terephthaloyl chloride, isophthaloyl chloride, phthaloyl chloride, and the like; and mixtures thereof.

In still another embodiment, the at least one aromatic carboxylic acid or anhydride of component (i), is selected from terephthalic acid, isophthalic acid, phthalic anhydride, and/or mixtures thereof.

In yet another embodiment, an aliphatic polycarboxylic acid or anhydride may be used in combination with the at least one aromatic carboxylic acid or anhydride of component (i) for preparing the aromatic polyester polyol. An aliphatic polycarboxylic acid and anhydride suitable for use in the present invention includes oxalic acid, malonic acid, glutaric acid, adipic acid, adipic anhydride, succinic acid, succinic anhydride, sebacic acid, pimelic acid, suberic acid, dodecanedioic acid, azelaic acid, citric acid, isocitric acid, 1,4-cyclohexanedicarboxylic acid, methylhexahydrophthalic anhydride, hexahydrophthalic anhydride and the like.

When an aliphatic polycarboxylic acid or anhydride is used in combination with the at least one aromatic carboxylic acid in component (i), the molar amount of carboxylic acid group and/or carboxylic acid equivalent group from the aromatic carboxylic acid, aromatic anhydride or aromatic carboxylic acid sources with respect to the total moles of carboxylic acid group in component (i) is in the range of from 25 mol % to 100 mol % in one embodiment, from 35 mol % to 100 mol % in another embodiment, from 50 mol % to 100 mol % in still another embodiment, from 60 mol % to 100 mol % in yet another embodiment, and from 75 mol % to 100 mol % in even still another embodiment, based on the total moles of carboxylic acid group used in the preparation of the aromatic polyester polyol, wherein each anhydride group in component (i) is equivalent to two carboxylic acid groups. In the above combination, if the polyester polyol is prepared with greater than 75 mol % of aliphatic carboxylic acid group, the polyester polyol tends to have inferior fire performance properties when used for making PU foams compared to the aromatic polyester polyol prepared from a lesser amount of aliphatic carboxylic acid group.

When an aliphatic polycarboxylic acid or anhydride is used with the at least one aromatic carboxylic acid in component (i), the total aromatic content of the carboxylic acids and/or the anhydrides is at least 7 wt % in one embodiment; at least 10 wt % in another embodiment; at least 15 wt % in still another embodiment; at least 20 wt % in yet another embodiment; at least 25 wt % in even still another embodiment; at least 30 wt % in even yet another embodiment; at least 35 wt % in another embodiment; at least 40 wt % in still another embodiment; and at least 45 wt % in yet another embodiment while having ≤65 wt % in still another embodiment. The wt % of the aromatic carboxylic acid or the anhydride (including their ester or halide derivatives and including mixtures with non-aromatic carboxylic acids or anhydrides) is calculated by taking the combined molecular weight of aromatic carbons and hydrogens bonded to aromatic carbons and dividing by the formula molecular weight of polycarboxylic acid and/or anhydride (including derivatives) and multiplying by 100. For example, terephthalic acid has a formula molecular weight of 166.1 with an aromatic content of C₆H₄ for a molecular weight 76.1. Therefore, the wt % aromatic content of terephthalic acid=(76.1/166.1) 100=45.8 wt %. For example, 2,6-napthalene dicarboxylic acid has a formula weight of 216.2 g/mol and an aromatic content of C₁₀H₆ for a molecular weight of 126.2. Therefore, the wt % aromatic content of 2,6-napthalene dicarboxylic acid=(126.2/216.2) 100=58.4 wt %. For example, a 75/25 wt/wt ratio of terephthalic acid/adipic acid, the wt % aromatic content of the combined polycarboxylic acids=[(45.8%×(75/100)]100=34.4 wt %.

Generally, the concentration of component (i) used to make the aromatic polyester polyol in the range of from 15 wt % to 65 wt % in one embodiment; from 20 wt % to 60 wt % in another embodiment; and from 25 wt % to 55 wt % in still another embodiment, based on the total amount of component (i) and (ii) used for preparing the novel liquid aromatic polyester polyol.

Suitable polyalicyclic alcohols, component (ii), useful for preparing the aromatic polyester polyol of the present invention include, for example, (1) polyalicyclic alcohols (Structure II, including one or more alkyl substituents on the ring structures where the alkyl substituents are from C1 to C6 carbon atoms); (2) ethoxylate or propoxylate of polyalicyclic alcohols; or (3) mixtures thereof. Suitable polyalicyclic alcohols have more than one alcohol group, but no more than four alcohol groups.

As an illustrative example, the polyalicyclic alcohol can include one or more of the following compounds tricyclo[5.2.1.0^{2,6}]decanedimethanol; bicyclo[2.2.1]heptane-2,3-dimethanol; bicyclo[2.2.2]octane-1,4-dimethanol; and isomers thereof, as well as tricyclo[3.3.1.1^{3,7}]decane-1,3-dimethanol; or mixtures thereof. “Tricyclo[5.2.1.0^{2,6}]-decanedimethanol” is also known as octahydro-4,7-methano-1H-indenedimethanol, as tricyclodecanedimethanol and as bis(hydroxymethyl)tricyclo[5,2,1,0^{2,6}]decane (among other names) which can be used interchangeably and also includes various positional isomers individually and in combinations thereof. For example, some of the positional isomers include and can be named as 3,8-bishydroxymethyl tricyclo[5.2.1.0^{2,6}]decane, 3,9-bishydroxymethyl tricyclo[5.2.1.0^{2,6}]decane, 4,8-bishydroxymethyl tricyclo[5.2.1.0^{2,6}]decane, and 4,9-bishydroxymethyl tricyclo[5.2.1.0^{2,6}]decane.

In one embodiment, the polyalicyclic alcohol useful is tricyclodecanedimethanol/tricyclo[5.2.1.0^{2,6}]decanedimethanol (TCDDM) having the following chemical structure:

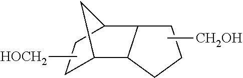

which includes the positional isomers (and mixtures thereof).

Other polyalicyclic alcohols that may be useful include one or more of the following compounds: 2,2-bis(4-hydroxycyclohexyl) propane and its positional isomers; (3-hydroxymethyl)-1-adamantanol and its positional isomers; isosorbide; 1,3-adamantanediol; 4,4′-bicyclohexanol and its positional isomers; 1,3,5-adamantatetriol and its positional isomers; 3,9-bis(1,1-dimethyl-2-hydroxyethyl)2,4,8,10-tetraoxaspiro[5.5]undecane; and mixtures thereof.

In one embodiment, optionally at least one diol or triol of non-polyalicyclic structure may be used in combination with the at least one polyalicyclic alcohol of component (ii) for preparing the aromatic polyester polyol. For example, the non-polyalicyclic structure may include one or more diols and triols, such as ethylene glycol (EG), diethylene glycol (DEG); dipropylene glycol (DPG); triethylene glycol, tetraethylene glycol; polyethylene glycol (PEG) for example PEG 200 (nominal Mₙ=200 g/mol), PEG 400 (nominal Mₙ=400 g/mol), and/or PEG 600 (nominal Mₙ=600 g/mol); polypropylene glycol (PPG); polytetramethylene glycol; 1,3-propanediol; 1,5-pentanediol; neopentyl glycol; glycerol; trimethylolpropane; 1,3-butanediol; 1,4-butenediol; 1,4- and 2,3-butylene glycol; 1,4-butynediol; 1,6-hexanediol; 1,8-octanediol; 2-methyl-1,3-propanediol; 3-methyl-1,5-pentanediol; 2-methyl-2,4-pentanediol; 1,2,6-hexanetriol; 1,2,4-butanetriol; trimethylolethane; dibutylene glycol; polybutylene glycols; polyols with hydroxyl equivalent weights from 85 g/mol to 1100 g/mol such as polyether polyols like VORANOL™ CP 450 and VORANOL™ CP 260, both which are available from Dow Inc.; aromatic polyester polyols; aliphatic polyester polyols; polyester-ether polyols; polycarbonate polyols; and the like; and mixtures thereof.

In still other embodiments, optionally the diol and/or triol of polyethylene glycol, PEG 200, diethylene glycol, triethylene glycol, tetraethylene glycol, trimethylolpropane and glycerol which are used with the at least one aromatic carboxylic acid or anhydride, component (i), are useful for combining with a polyalicyclic alcohol, component (ii), to prepare the novel liquid aromatic polyester polyol of the present invention.

In still another embodiment, optionally the non-polyalicyclic diol PEG 200 which is used with the aromatic carboxylic acid or anhydride, component (i), is useful for combining with a polyalicyclic alcohol, component (ii), to prepare the novel liquid aromatic polyester polyol of the present invention.

In another embodiment, the amount of at least one polyalicyclic alcohol with respect to the amount of all polyhydric alcohols used for preparing the aromatic polyester polyol of the present invention is in the range of from 10 mol % to 90 mol % in one embodiment, from 15 mol % to 85 mol % in another embodiment, and from 20 mol % to 80 mol % in still another embodiment, wherein the mol % is calculated by dividing the moles of hydroxyl group of the at least one polyalicyclic alcohol by the moles of hydroxyl group from all the polyhydric alcohols (i.e., both polyalicyclic and non-polyalicyclic type) used for the preparation of the aromatic polyester polyol. When the usage amount for the at least one polyalicyclic alcohol is >90 mol %, the viscosity of the aromatic polyester polyol tends to be too high for practical use such as handling and mixing, whereas when the usage amount for the at least one polyalicyclic alcohol is <10 mol %, the resulting aromatic polyester polyol leads to a weak improvement.

In yet another embodiment, the amount of at least one polyalicyclic alcohol of component (ii) used to make the aromatic polyester polyol is in the range of from 4 wt % to 70 wt % in one embodiment; from 6 wt % to 60 wt % in another embodiment; and from 12 wt % to 50 wt % in still another embodiment, based on the total amount of component (i) and (ii) used for preparing the novel liquid aromatic polyester polyol.

Generally, the concentration of component (ii) including at least one polyalicyclic alcohol and optionally at least one diol or triol of non-polyalicyclic structure for making the aromatic polyester polyol of the present invention is in the range of from 35 wt % to 85 wt % in one embodiment; from 40 wt % to 80 wt % in another embodiment; and from 45 wt % to 75 wt % in still another embodiment, based on the total amount of component (i) and (ii) used for preparing the novel liquid aromatic polyester polyol.

Other additional optional components, component (iii), can be used in preparing the aromatic polyester polyol. In one embodiment, the other additional optional components, component (iii), can include, for example, but are not limited to, esterification catalysts, transesterification catalysts, antioxidants; and a mixture thereof.

Esterification catalysts and transesterification (i.e. ester interchange, glycolysis) catalysts include compounds containing a metal element belonging to the Group 1 to the Group 14 of the periodic table exclusive of hydrogen and carbon as well as Lewis or Bronsted acids. Specifically, examples thereof include organic group-containing compounds such as carboxylates, alkoxy salts, organic sulfonates, β-diketonate salts, and the like, each containing at least one metal such as titanium, zirconium, and germanium; inorganic compounds such as oxides or halides of the foregoing metals, and mixtures thereof. For example, in one embodiment, the titanium compounds include titanium acetylacetonate and/or tetraalkyl titanates such as tetra-n-propyl titanate. In another embodiment, an example of the zirconium compound includes zirconium tetraacetate. And, in still another embodiment, an example of the germanium compound includes inorganic germanium compounds such as germanium oxide; and organic germanium compounds such as a tetraalkoxy germanium. Other examples of catalysts useful in the present invention are described, for instance, in U.S. Pat. No. 10,619,000.

Generally, the other additional optional components, component (iii), used for preparing the aromatic polyester polyol, if used, can be in the range of from 0 wt % to 5 wt % in one embodiment; from 0.001 wt % to 2 wt % in another embodiment; and from 0.01 wt % to 1 wt % in still another embodiment, based on the total amount of components (i) and (ii) used for preparing the liquid aromatic polyester polyol of the present invention.

Additionally, the aromatic polyester polyol of the present invention may be further modified by the addition of a different polyol such as a different polyester polyol, polyether polyol, polycarbonate polyol, and/or a thermoplastic polymer such as polyester, polycarbonate, and the like with an optional transesterification catalyst and with the application of heat ranging from 50° C. to 290° C. for a period of time ranging from 1 minute to 12 hours.

In a broad embodiment, the process for producing the liquid aromatic polyester polyol of the present invention includes a mixing, combining or blending: (i) a predetermined amount of at least one aromatic carboxylic acid, aromatic carboxylic anhydride, or aromatic carboxylic acid source suitable for preparing the aromatic polyester polyol of the present invention; (ii) a predetermined amount of at least one polyalicyclic alcohol suitable for preparing the aromatic polyester polyol of the present invention, and optionally at least one diol or triol of non-polyalicyclic structure; and (iii) any other additional optional component such as esterification catalysts, transesterification catalysts, and/or antioxidants, if desired, under process conditions such that the above compounds are thoroughly mixed together and reacted to form the liquid aromatic polyester polyol comprising at least one polyalicyclic structure. As stated earlier, illustrative examples of an aromatic carboxylic acid source include a liquid or a solid aromatic polyester polyol, separate and different from the aromatic polyester polyol of the present invention; a solid thermoplastic aromatic polyester such as polyethylene terephthalate (PET), recycled PET, and the like.

In one embodiment of the above process, the water content of component (i) and/or component (ii) is from 0 ppm to ≤20,000 ppm in one embodiment, from 0.01 ppm to <10,000 ppm in another embodiment, and from 0.1 ppm to <1,000 ppm in still another embodiment. In other embodiments, the water content can be <500 ppm in one embodiment and <250 ppm in another embodiment.

In another embodiment, the process for producing the liquid aromatic polyester polyol comprising at least one polyalicyclic structure is carried out at a temperature of at least 130° C. in one embodiment, at least 150° C. in another embodiment, and 180° C. in still another embodiment. In other embodiments, the process for producing the liquid aromatic polyester polyol comprising at least one polyalicyclic structure is carried out at a temperature of ≤240° C. in one embodiment, ≤260° C. in another embodiment, and ≤290° C. in still another embodiment.

In still another embodiment, the process for producing the liquid aromatic polyester polyol comprising at least one polyalicyclic structure is carried out under an inert atmosphere using an inert gas such as N2, argon, and the like; and at a pressure of from atmospheric pressure (760 Torr/101 kPa) to a pressure of ≥1 Torr/0.1 kPa in one embodiment, from atmospheric pressure to a pressure of ≥10 Torr/1 kPa in another embodiment, and from atmospheric pressure to a pressure of ≥100 Torr/13 kPa. The time of reaction can be from a few minutes to hours as is known in the art.

In yet another embodiment, the process for producing the liquid aromatic polyester polyol comprising at least one polyalicyclic structure utilizes a molar excess of alcohol from the combined polyalicyclic alcohol with optional diols and/or triols relative to carboxylic acid equivalents, with the respective mole ratio of ≤4.00 in one embodiment, ≤3.00 in another embodiment, ≤2.50 in still another embodiment, and ≤2.10 in yet another embodiment. In other embodiments, the mole ratio is ≥1.10 in one embodiment, ≥1.20 in another embodiment, ≥1.50 in still another embodiment, and >1.70 in yet another embodiment. When an alternative source of carboxylic acid is used for the preparation of the liquid aromatic polyester polyol of the present invention, the molar amount of carboxylic acid for those alternative sourcing needs to be treated differently from a regular polycarboxylic acid, as follows: each anhydride group is equivalent to two carboxylic acid group, each ester linkage pre-formed in materials like PET is equivalent to one carboxylic acid group and one hydroxyl group, and the like. The calculation of molar ratio of hydroxyl group and carboxylic acid group needs to take into account of all the sourcing of hydroxyl group and carboxylic acid group in components (i) and (ii).

In even still another embodiment, the liquid aromatic polyester polyol comprising at least one polyalicyclic structure of the present invention can be prepared by the steps of: (1) loading a predetermined amount of at least one aromatic carboxylic acid, or at least one aromatic carboxylic anhydride, or at least one aromatic carboxylic acid source, at least one polyalicyclic alcohol, at least one optional diol or triol and at least one optional esterification/transesterification catalyst into a reactor with agitation; (2) providing an inert atmosphere to the reactor contents with inert gas (e.g., N2 or argon) with optional application of reduced pressure (<760 Torr/101 kPa); (3) stirring/mixing the reactor contents with heating to a temperature between 130° C. and 290° C. and substantially simultaneously removing from the reactor condensate product from reaction of carboxylic acid (including its derivatives) with alcohol, diol, and/or triol wherein such removal from the reactor can be carried out by distillation under inert gas stream and/or reduced pressure with optional addition of esterification/transesterification catalyst and optional addition of polyalicyclic alcohol, diol, and/or triol; (4) optionally adding a polyalicyclic alcohol, diol, and/or triol to transesterify under N2 without removal by distillation of products or by-products, upon completion of the reaction in step (3) based upon distillate mass, hydroxyl number measurement, acid number measurement, and/or molecular weight moment measurement; and (5) transferring the resulting liquid aromatic polyester polyol comprising at least one polyalicyclic structure from the reactor to a storage vessel at a temperature ranging from room temperature to as high as the process temperature of 290° C.

Typically, an aromatic carboxylic acid or anhydride is used in the process because the condensate by-product formed is water (and water is not flammable). In another embodiment, esters such as dimethyl terephthalate can be used when the production process may be run at a lower temperature point in the range of from 130° C. to 290° C. (e.g. <240° C.) due to some monomer stability concern or if diacid purity is poor. In addition, generally a titanate catalyst is used in the process; however, in another embodiment, an ethylene glycol can be used in combination with a different catalyst type such as germanium oxide. In one embodiment, the catalyst is added to the reaction mixture at the start of the reaction when loading the other components; in another embodiment, the catalyst is added to the reaction mixture during warming of the reaction mixture to the reaction temperature; in still another embodiment, catalyst is added to the reaction mixture after an amount of condensate by-product has been removed from the reaction mixture; and in yet another embodiment, the catalyst is added to the reaction mixture in any combination of two or more of the above periods of time, i.e., at the start of the reaction, during the warming of the reaction to reaction temperature, and/or after an amount of condensate by-product has been removed from the reaction.

Some of the advantageous properties exhibited by the resulting liquid aromatic polyester polyol of the present invention produced according to the above described process, can include, for example: (1) a pourable viscosity of <100 Pa-s between 20° C. and 50° C.; (2) a hydroxyl number of ≤500 mg KOH/g; (3) an acid number of ≤10 mg KOH/g; (4) a number average molecular weight of ≤2,000 g/mol; (5) a hydroxyl functionality of <4.0; (6) an optical clarity or transparency at ambient temperature; (7) a glass transition temperature ≤0° C. and (8) improved miscibility with physical blowing agent such as cyclopentane, iso-pentane, and the like.

For example, the viscosity of the aromatic polyester polyol at 26° C. and 10 sec⁻¹ can range from 0.5 Pa-s to 100 Pa-s in one embodiment; from 1.0 Pa-s to 90 Pa-s in another embodiment, and from 2.0 Pa-s to 75 Pa-s in still another embodiment. The viscosity of the aromatic polyester polyol can be measured by a rotational rheometer, for example, in accordance with the procedure described in ISO3219.

Another property of the aromatic polyester polyol that is particularly useful for making polyurethane or polyisocyanurate foams is the polyester polyol's hydroxyl number (OH #). The OH # property of the polyol can range from 100 mg KOH/g to 500 mg KOH/g in one embodiment; from 150 mg KOH/g to 450 mg KOH/g in another embodiment, from 175 mg KOH/g to 425 mg KOH/g in still another embodiment, and from greater than 200 mg KOH/g to no more than 400 mg KOH/g in yet another embodiment. The OH # of the polyol can be determined, for example, according to conventional processes such as the procedure described in ASTM E1899-16.

Still another property of the aromatic polyester polyol that is enhanced or maintained is the polyester polyol's acid number. The acid number property of the aromatic polyester polyol can range from 0 mg KOH/g to 10 mg KOH/g in one embodiment; from 0.01 mg KOH/g to 7.5 mg KOH/g in another embodiment, from 0.1 mg KOH/g to 5.0 mg KOH/g in still another embodiment, and from 0.1 mg KOH/g to 2.0 mg KOH/g in yet another embodiment. The acid number (acid #) of the aromatic polyester polyol can be determined, for example, by the potentiometric titration of polyol dissolved in a solvent such as toluene or methanol with standardized 0.01 N potassium hydroxide using a conventional titration system.

Yet another property of the aromatic polyester polyol that is enhanced or maintained is the polyester polyol's hydroxyl group (OH) average functionality (i.e., the average number of hydroxyl groups per molecule). The average OH functionality of the aromatic polyester polyol can range from at least 1.8 to 4.0 in one embodiment; at least 2.0 to 3.5 in another embodiment; from at least 2.0 to 3.0 in still another embodiment; and from at least 2.0 to 2.7 in yet another embodiment.

Even still another property of the aromatic polyester polyol that is enhanced or maintained is the polyester polyol's molecular weight. The number average molecular weight (Mₙ) property of the aromatic polyester polyol can range from 250 g/mol to 2,000 g/mol in one embodiment; from 275 g/mol to 1,750 g/mol in another embodiment; from 300 g/mol to 1,500 g/mol in still another embodiment, from 300 g/mol to 1,250 g/mol in yet another embodiment, from 300 g/mol to 1,000 g/mol in even still another embodiment, and from 325 g/mol to 900 g/mol in even yet another embodiment. The molecular weight (e.g., number average molecular weight (Mₙ), weight average molecular weight (M_{w}), and polydispersity index (PDI)=M_{w}/Mₙ)) of the aromatic polyester polyol can be determined, for example, according to the procedure described in ASTM D5296.

Even still another property of the aromatic polyester polyol that is enhanced or maintained is a glass transition temperature (T_{g}) that is lower than ambient room temperature. The T_{g} property of the aromatic polyester polyol is <0° C. in one embodiment; <−10° C. in another embodiment; <−20° C. in still another embodiment; <−30° C. in yet another embodiment. In even still another embodiment, the Tg of the aromatic polyester polyol is >−75° C. The glass transition temperature is measured according to ASTM E1356-08(2014) utilizing the midpoint temperature for T_{g}.

The reaction scheme for preparing a PU foam is well known in the art; and generally includes reacting an “A-side material” with a “B-side material”, wherein the A-side material includes at least one isocyanate-containing material (herein component (a)); and wherein the B-side material includes at least one isocyanate-reactive material such as a polyol, usually a blend of materials wherein at least one of the materials is a polyol, (herein component (b)). Other optional additional foaming components, component (c), such as a foaming catalyst, a blowing agent, and a surfactant, and the like can be added to the A-side material and/or the B-side material or mixed with the A-side material and the B-side material as a separate stream to provide a reactive foam-forming composition useful for forming the PU foam.

Generally, the PU foam-forming composition of the present invention is produced by admixing the polyol-containing material (the B-side) which includes the novel liquid aromatic polyester polyol with at least one polyalicyclic structure described above; and the isocyanate-containing material (A-side). The resulting reactive PU foam-forming composition, in turn, is used in a process for producing a polyurethane foam article. For example, in preparing a PU foam article or product, the A-side material and the B-side material is first prepared; wherein the A-side material includes at least one isocyanate-containing material and wherein the B-side includes at least one aromatic polyester polyol of the present invention. Then, the A-side material and B-side material are mixed together to form the PU foam-forming reaction mixture. The reactive blend is then subjected to conditions sufficient to cure the reactive blend to form a PU foam. Other optional foaming components, auxiliary additives or compounds can be added to the A-side material, to the B-side material, or to both the A-side material and the B-side material, or mixed with the A-side material and the B-side material as a separate stream.

Generally, suitable isocyanate-containing material/polyisocyanate compounds (A-side) or component (a), for use in preparing the PU foam may include any of the organic isocyanates known in the art that contain more than one isocyanate (NCO) group for preparing polyurethanes, such as aliphatic, cycloaliphatic, araliphatic and aromatic isocyanates. In one embodiment, aromatic polyisocyanates are generally preferred based on cost, availability, reactivity and properties imparted to the polyurethane product. Exemplary polyisocyanates useful in the present invention include, for example, m-phenylene diisocyanate; 2,4- and/or 2,6-toluene diisocyanate (TDI); various isomers of diphenylmethanediisocyanate (MDI); hexamethylene-1,6-diisocyanate; tetramethylene-1,4-diisocyanate; cyclohexane-1,4-diisocyanate; hexahydrotoluene diisocyanate; hydrogenated MDI (H₁₂ MDI); naphthylene-1,5-diisocyanate; methoxyphenyl-2,4-diisocyanate; 4,4′-biphenylene diisocyanate; 3,3′-dimethoxy-4,4′-biphenyl diisocyanate; 3,3′-dimethyldiphenylmethane-4,4′-diisocyanate; 4,4′,4″-triphenylmethane triisocyanate; polymethylene polyphenylisocyanates or mixtures thereof with MDI (polymeric MDI), hydrogenated polymethylene polyphenylisocyanates, toluene-2,4,6-triisocyanate, and 4,4′-dimethyl diphenylmethane-2,2′,5,5′-tetraisocyanate; naphthyl diisocyanate; isocyanate prepolymer(s); and mixtures of two or more of the above isocyanates.

The isocyanate compound useful in the present invention may be a modified multifunctional isocyanate, that is, a product which is obtained through chemical reactions of an isocyanate compound. Exemplary are polyisocyanates containing esters, ureas, biurets, allophanates and carbodiimides and/or uretoneimines. In one embodiment, the polyisocyanates that can be used in forming the polyurethane foam-forming composition of the present invention may include MDI and derivatives of MDI such as uretdione, isocyanurate, carbodiimide, uretonimine, allophanate and biuret-modified “liquid” MDI products and polymeric MDI, as well as mixtures of the 2,4- and 2,6-isomers of MDI.

In one embodiment, the polyisocyanate is a polymerized or oligomerized compound of monomeric isocyanate, commonly referred to as polymeric isocyanate. As used herein “polymeric”, in describing the isocyanate, refers to high molecular weight homologues and/or isomers. For instance, polymeric methylene diphenyl isocyanate refers to a high molecular weight homologue and/or an isomer of methylene diphenyl isocyanate. VORANATE™ M229, VORANATE™ M600, and PAPI™ 580N are examples of several commercial polymeric MDI materials useful in the present invention. The above VORANATE™ and PAPI™ products are available from Dow Inc. In another embodiment, the isocyanate useful in the present invention may be prepared by any of the processes known to those skilled in the art of producing polyisocyanates.

Alternatively, or additionally, the isocyanate component may also comprise an isocyanate prepolymer. The isocyanate prepolymer is known in the art; and in general, is prepared by reacting (1) at least one isocyanate compound and (2) at least one polyol compound with the molar amount of isocyanate groups greater than the molar amount of hydroxyl groups. The isocyanate prepolymer can be obtained by reacting the above stated monomeric isocyanate compounds or polymeric isocyanate with one or more polyols.

In one embodiment, the polyisocyanate or mixture thereof, in general, can have an average of 1.8 or more isocyanate groups per molecule. In another embodiment, the isocyanate functionality may be from 1.9 to 4, from 1.9 to 3.5 in still another embodiment, from 2.0 to 3.5 in yet another embodiment, from 2.2 to 3.5 in even still another embodiment, and from 2.5 to 3.3 even yet another embodiment.

The isocyanate component may have an isocyanate equivalent weight of from 80 g/eq to 300 g/eq. All individual values and subranges from 80 g/eq to 300 g/eq are included; for example, the isocyanate may have an isocyanate equivalent weight from a lower limit of 80 g/eq, 90 g/eq, or 100 g/eq to an upper limit of 300 g/eq, 290 g/eq, or 280 g/eq.

In certain embodiments, the isocyanate has a viscosity measured in accordance with ASTM D4889-15, at 25° C., of from 5 mPa-s to 10,000 mPa-s. Other viscosity values may also be possible. For example, in other embodiments, the isocyanate compound can have a viscosity value, at 25° C., of from a lower value of 5 mPa-s, 10 mPa-s, 25 mPa-s, 50 mPa-s or 100 mPa-s to an upper value of 1,000 mPa-s, 2,000 mPa-s, 3,500 mPa-s, 5,000 mPa-s or 10,000 mPa-s.

Generally, the amount of the isocyanate component used in the foam-forming composition of the present invention may vary based on the end use of the rigid PU foam. For example, the concentration of the isocyanate component can be from 20 wt % to 80 wt % in one general embodiment, from 25 wt % to 80 wt % in another embodiment, and from 30 wt % to 75 wt % in still another embodiment, based on the total weight of all the components in the reactive foam-forming composition for preparing the rigid PU foam.

The stoichiometric ratio of the isocyanate groups in the isocyanate component to the hydroxyl groups in the isocyanate-reactive component (e.g., polyol, water, and the like) is between 1.0 and 6. This ratio multiplied by 100 is typically referred as isocyanate index. The isocyanate index of the foam-forming composition of the present invention may be from 100 to 600 in one embodiment, from 120 to 575 in another embodiment, from 150 to 550 in still another embodiment, from 175 to 500 in yet another embodiment, from 200 to 475 in even still another embodiment, and from 250 to 450 in even yet another embodiment.

The isocyanate-reactive component or component (b) of the foam-forming composition of the present invention comprises the novel liquid aromatic polyester polyol with at least one polyalicyclic structure as described above, and is combined with the isocyanate component (A-side) or component (a) to produce a foam-forming composition. The novel aromatic polyester polyol of the present invention provides a PU foam with improved thermal insulation performance, smaller cell size, and other excellent properties.

In another embodiment, the isocyanate-reactive component or component (b) may further include at least one other polyol that is different from the novel aromatic polyester polyol with at least one polyalicyclic structure of the present invention, and such other polyol is selected from a polyester polyol; a polyether polyol; a polycarbonate polyol; or mixtures thereof. When at least one other polyol, different from the present invention aromatic polyester polyol, is used in component (b) of the foam-forming composition of the present invention, the amount of the novel aromatic polyester polyol with at least one polyalicyclic structure is at least 10 parts (pts) in one embodiment; at least 15 pts in another embodiment; at least 25 pts in still another embodiment; at least 35 pts in yet another embodiment; at least 45 pts in even still another embodiment; at least 50 pts in even yet another embodiment; and at least 55 pts in another embodiment, all the parts are by weight and based on the total amount of polyols in the isocyanate-reactive component (b) equal to 100 parts.

In general, the non-polyalicyclic type polyol useful for the foam-forming composition of in the present invention can have an average hydroxyl functionality in the range from 1.8 to 7.5, an average hydroxyl number of from 75 mg KOH/g to 650 mg KOH/g, a number average molecular weight of from 100 g/mol to 1,500 g/mol, and a hydroxyl equivalent molecular weight of from 50 g/eq to 750 g/eq.

The other optional additional foaming components, component (c), useful in preparing the foam-forming composition of the present invention can include for example, one or more additional types of other materials, as may be useful in the manufacturing process used to make the foam-forming composition or to impart desired characteristics to the resulting foam product, may be used, including for example, but are not limited to, foaming catalysts, surfactants, physical or chemical blowing agents, flame retardant (FR) additives, and the like; and mixtures thereof.

For the various embodiments, the foaming catalyst may be a blowing catalyst, a gelling catalyst, a trimerization catalyst, or combinations thereof. In one embodiment, a combination of the above catalysts is used. For example, any conventional blowing catalyst, e.g., a catalyst that tends to favor the urea (blow) reaction, may be used according to the present invention, such as bis-(2-dimethylaminoethyl)ether; N,N,N′,N″,N″-pentamethyldiethylene-triamine; triethylamine, tributyl amine; N,N-dimethylaminopropylamine; dimethylethanol-amine; N,N,N′,N′-tetramethylethylenediamine; and combinations thereof. An example of a commercial blowing catalyst is POLYCAT® 5, available from Evonik. When used, the blowing catalyst may be present in an amount of from 0.05 pts to 5 pts in one general embodiment (e.g., from 0.1 pts to 3.5 pts in one embodiment, from 0.2 pts to 2.5 pts in another embodiment, and from 0.5 pts to 2.5 pts in still another embodiment), based on 100 pts of total polyols amount in the isocyanate-reactive component.

Any conventional gelling catalyst, e.g., a catalyst that tends to favor the urethane (gel) reaction, may be used according to the present invention, such as: (1) organometallic compounds including tin(II) salts of organic carboxylic acids (e.g., tin(II) diacetate), salts of organic carboxylic acids (e.g., dibutyltin diacetate), and bismuth salts of organic carboxylic acids (e.g., bismuth octanoate); and (2) cyclic tertiary amines and/or long chain amines including dimethylbenzylamine, triethylenediamine, and combinations thereof. Examples of commercially available gelling catalysts are POLYCAT® 8, DABCO® 33-LV, and DABCO® T-12, all available from Evonik. When used, the gelling catalyst may be present in an amount of 0.05 pts to 5 pts in one general embodiment (e.g., from 0.1 pts to 3.5 pts in one embodiment, from 0.2 pts to 2.5 pts in another embodiment, and from 0.5 pts to 2.5 pts in still another embodiment), based on 100 pts of total polyols amount in the isocyanate-reactive component.

Any conventional trimerization catalyst, e.g., a catalyst that is utilized to promote the formation of isocyanurate structure in compositions, may be used according to the present invention such as N,N′,N″-tris(3-dimethylaminopropyl)hexahydro-S-triazine; potassium acetate; tetraalkylammonium hydroxides (e.g., tetramethylammonium hydroxide); alkali metal hydroxides (e.g., sodium hydroxide); alkali metal alkoxides (e.g., sodium methoxide); and combinations thereof. Some commercially available trimerization catalysts include, for example, DABCO® TMR-2, DABCO® TMR-20, DABCO® TMR-30, DABCO® TMR-7, DABCO® K 2097; DABCO® K15, POLYCAT® 41, and POLYCAT® 46, each available from Evonik. When used, the trimerization catalyst may be present in an amount of from 0.05 pts to 5 pts in one general embodiment (e.g., from 0.1 pts to 3.5 pts in one embodiment, from 0.2 pts to 2.5 pts in another embodiment, and from 0.5 pts to 2.5 pts in still another embodiment), based on 100 pts of total polyols amount in the isocyanate-reactive component.

For various embodiments, the foam-forming composition of the present invention may include at least one blowing agent. The blowing agent may be selected based at least in part on, for example, the desired density of the final foam, the blowing agent's miscibility in the foam-forming composition such as in the polyol component, and the blowing agent's compatibility with other components in the foam-forming composition. For example, any conventional chemical and/or physical blowing agent may be used in the production of PU foams such as water, formic acid, methyl formate, various low boiling hydrocarbons (e.g., heptane, hexane, n-pentane, iso-pentane, butane, cyclopentane, cyclohexane, and the like; and mixtures thereof), various low boiling ketones such as acetone and methyl ethyl ketone, various hydrochlorofluorocarbons (HCFCs) such as 1,1-dichloro-1-fluoroethane, various hydrofluorocarbons (HFCs) such as 1,1,1,3,3-pentafluoropropane, various hydrofluoroolefins (HFOs) such as trans-1,3,3,3-tetrafluoroprop-1-ene, 1,3,3,3-tetrafluoropropene, and the like; and mixtures thereof. Some commercially available hydrofluoroolefin blowing agents useful in the present invention include Solstice® LBA and Solstice® GBA, available from Honeywell; and Opteon™ 1100 and Opteon™ 1150, available from Chemours. Mixtures of these low boiling liquids with each other and/or with other substituted or unsubstituted hydrocarbons can also be used. In various embodiments, the amount of the at least one blowing agent is from 0.1 pts to 40 pts (e.g., from 0.5 pts to 35 pts, from 1 pts to 30 pts, or from 5 pts to 25 pts) based on 100 pts of total polyols amount in the isocyanate-reactive component.

For various embodiments, the foam-forming composition of the present invention may include a surfactant. The surfactant may be a cell-stabilizing surfactant, i.e., a surfactant that is employed in amounts sufficient to stabilize the foaming reaction against collapse and the formation of large uneven cells. Examples of suitable surfactants include silicone-based surfactants such as polysiloxane polyoxylalkylene block copolymers disclosed in U.S. Pat. Nos. 2,834,748; 2,917,480; and 2,846,458; and organic-based surfactants containing polyoxyethylene-polyoxybutylene block copolymers such as those described in U.S. Pat. No. 5,600,019. Other surfactants useful in the present invention include polyethylene glycol ethers of long-chain alcohols, tertiary amine or alkanolamine salts of long-chain allyl acid sulfate esters, alkylsulfonic esters, alkyl arylsulfonic acids, and combinations thereof. Some commercially available surfactants useful in the isocyanate-reactive composition include VORASURF™ DC 193, VORASURF™ RF 5374, VORASURF™ DC 5604, VORASURF™ SF 2937, VORASURF™ SF 2938, VORASURF™ DC 5098, and VORASURF™ 504, all available from Dow Inc.; TEGOSTAB® B8418, TEGOSTAB® B8491, TEGOSTAB® B8421, TEGOSTAB® B8461, and TEGOSTAB® B8462, all available from Evonik Industries AG; and NIAX* L-6988, NIAX* L-6642, and NIAX* L-6633, all available from Momentive. The amount of surfactant, when used, may be from 0.1 pts to 10.0 pts in one general embodiment, based upon 100 pts of total polyols present in the isocyanate-reactive component. All individual values and subranges within the range of from 0.1 pts to 10.0 pts are included; for example, the surfactant concentration may be from a lower limit of 0.1 pts, 0.2 pts, or 0.3 pts to an upper limit of 10.0 pts, 9.0 pts, 7.5, or 6 pts, based upon 100 pts of total polyols present in the isocyanate-reactive component.

For various embodiments, the foam-forming composition of the present invention may include a halogenated or non-halogenated flame retardant (FR) additive such as tris(1,3-dichloropropyl)phosphate, various halogenated aromatic compounds, triethyl phosphate, diethyl (hydroxymethyl)phosphonate, diethyl-N, N-bis(2-hydroxyethyl)aminomethyl phosphonate, aryl phosphate such as resorcinol bis(diphenyl phosphate) (e.g., FYROLFLEX RDP, available from ICL Industrial), antimony oxide, alumina trihydrate, and combinations thereof. When used, the flame retardant may be present in an amount of from 0.1 pts to 30 pts, 1 pts to 25 pts, 2 pts to 25 pts, or 5 pts to 25 pts, based on 100 pts of total polyols amount in the isocyanate-reactive component.

As aforementioned, component (c) includes other optional additional foaming components, and/or any number of a variety of other optional auxiliary additives useful for the production of the foam-forming composition of the present invention, which in turn, is used for forming PU foams. The other optional auxiliary additives can include, for example, liquid nucleating additives, solid nucleating agents, Ostwald ripening inhibitor additives, reactive or non-reactive diluents, expandable graphite, pigments, rheological modifiers, emulsifiers, antioxidants, mold release agents, dyes, pigments, fillers, and the like; and mixtures thereof. The amount of each of the other optional auxiliary additives used in the foam-forming composition of the present invention depends on specific application and foam processing condition. Each of the other optional auxiliary additives, if used, may be added to one or both of the A-side material and B-side material prior to the mixing of A-side and B-side or mixed online with the A-side and B-side as a separate stream during the foam production. The other optional auxiliary additives are used in amounts well known to skilled persons for their function and use, and are sometimes added directly to the isocyanate-reactive component (B-side) along with the aromatic polyester polyol. Generally, the other optional auxiliary additive in the foam-forming composition, if used, can be in the range of from 0.01 pts to 25 pts in one general embodiment; from 0.1 pts to 20 pts in another embodiment; and from 0.5 pts to 15 pts in still another embodiment, all based on 100 pts of total polyols amount in the isocyanate-reactive component.

As aforementioned, the process for producing a PU foam-forming composition of the present invention generally includes mixing: (a) a predetermined amount of at least one isocyanate component as the A-side component; and (b) a predetermined amount of the at least one isocyanate-reactive component as the B-side component; wherein the B-side component comprises the at least one isocyanate-reactive compound which is the liquid aromatic polyester polyol with at least one polyalicyclic structure; and (c) other optional additional foaming components and/or other optional auxiliary additives, if desired. The components above are typically prepared and stored separately until when a foam processing equipment is ready to take each individual component for a thorough mixing and an immediate injection, spray or deposition of the resulting reactive foam composition into a mold, onto a surface or on a substrate for subsequent foaming and curing into articles. Some or all of the components/additives of optional component (c), including the other optional additional foaming components and/or the other optional auxiliary additives, may be added to any one of the components of the foam-forming composition or added as a separate stream during the foam production. For example, optional component (c) can be added to one or both of the A-side material and B-side material prior to the mixing of A-side and B-side, i.e., optional component (c) can be pre-mixed into the isocyanate-reactive component (B-side) or the isocyanate component (A-side) before the A-side and B-side are mixed together. Alternatively, each component (c), when used in the present invention, may be introduced as a separate stream and mixed with the A-side and the B-side to produce a reactive foam-forming composition, i.e., each component (c) can be mixed online with the A-side and B-side as a separate stream during the foam production. For example, in one embodiment optional component (c) can be added directly to the isocyanate-reactive component (B-side) along with the aromatic polyester polyol. Irrespective of any particular method of mixing and the order of mixing each individual component for the production of the foam-forming composition, the reactive foaming mixture general has a high reactivity at room temperature and need to be used immediately for foam article fabrication after the foam-forming composition is prepared.

In one broad embodiment, the process of producing the polyurethane foam-forming composition of the present invention includes the steps of: (1) providing a reactor vessel or container to receive the above components to form a reaction mixture in the vessel; and (2) mixing the components in the reactor vessel or container to form a homogeneous reaction mixture. The ingredients that make up the foam-forming composition may be mixed together by any known mixing process and equipment that is typically used for polyurethane foam production. The order of mixing the ingredients is not critical and two or more compounds can be mixed together followed by addition of the remaining ingredients.

Generally, the process for making the reactive foam composition includes admixing components (a) and (b) described above; and if desired, optionally adding component (c), which includes one or more of the other optional additional foaming components such as a blowing agent, a catalyst, a surfactant, a fire retardant additive; and/or one or more of the other optional auxiliary additives; and mixtures thereof to the foam composition. The blowing agent, the catalyst, the surfactant, the fire retardant additive and the other optional auxiliary additives of components (c) may be added to the foam formulation into (1) the isocyanate component or A-side; (2) the isocyanate-reactive component or B-side, or (3) both the isocyanate component (A-side) and the isocyanate-reactive component (B-side); and each of the optional foaming components and/or optional auxiliary additives of component (c) can be added before the components (a) and (b) are mixed together or at the same time when the components (a) and (b) are mixed together.

In preparing the foam-forming composition of the present invention, the A-side and the B-side are separately and individually prepared with the other optional ingredients, if any; and all of the components can be mixed together in the desired concentrations discussed above to prepare the foam-forming composition. In general, the mole ratio of the isocyanate groups in the A-side to the isocyanate-reactive groups in the B-side can be in the range of from 1.0:1 to 6:1 in one embodiment, from 1.2:1 to 5.75:1 in another embodiment, from 1.5:1 to 5.5:1 in still another embodiment, from 1.75:1 to 5:1 in yet another embodiment, from 2:1 to 4.75:1 in even still another embodiment, and from 2.5:1 to 4.5:1 in even yet another embodiment. The mixing of the components (a) and (b) can be carried out at a temperature of from 5° C. to 80° C. in one embodiment; from 10° C. to 60° C. in another embodiment; and from 15° C. to 50° C. in still another embodiment. A typical time for mixing components (a), (b) and other optional component (c) into a reactive foam-forming composition at room temperature is from as short as 10 ms to 100 ms to as long as 20 s.

The ingredients that make up the foam composition may be mixed together by any known mixing process and equipment. For example, the isocyanate component (A-side) and the isocyanate-reactive component (B-side) can be mixed together by any known urethane foaming equipment such as a spray apparatus, a high pressure impingent mixer, a static mixer, a liquid dispensing gun, a mixing head, or a vessel. A high pressure impingent mixer and a spray apparatus are most commonly used for mixing the A-side and B-side as well as the optional components/additives of component (c). Immediately after mixing (e.g., in <5 s), the foam-foaming mixture may be sprayed or otherwise deposited or injected or poured onto a substrate or into a mold. Irrespective of any particular method of foam fabrication, the amount of the foaming mixture introduced into the mold or onto the substrate is enough to fully fill the mold or take the shape of a panel or any other functional shapes as the foam expands and cures. Some degree of overpacking may even be introduced by using a slight excess amount of the reaction mixture beyond minimally required. For example, the cavity may be overpacked by 5% to 35%, i.e., 5% to 35% by weight more of the reaction system beyond what is minimally required to fill the cavity once the reaction mixture expands. This cavity may be optionally kept at atmospheric pressure or partially evacuated to sub-atmospheric pressure.

The fully mixed reactive foam-forming composition is subjected to conditions sufficient to allow the foaming reaction to occur and to cure inside a cavity or a mold or on a substrate to form a rigid foam product. Upon reacting, the foaming mixture takes the shape of the mold or adheres to the substrate to produce a PU foam which is then allowed to cure, either partially or fully. Suitable conditions for promoting the curing of the polymer include a temperature of from 20° C. to 150° C. in one general embodiment. In some embodiments, the curing is performed at a temperature of from 30° C. to 80° C. In other embodiments, the curing is performed at a temperature of from 35° C. to 65° C. In various embodiments, the temperature for curing may be selected at least in part based on, for example, the time duration required for the PUR/PIR polymer to gel and/or cure at that particular temperature. Cure time will also depend on other factors, including, for example, the usage amount of particular components (e.g., type and amount of catalysts thereof), and the size and shape of the article being manufactured. Different articles being produced may include, but is not limited to, foam board for roofing, insulation panels for building and construction use, and door panels for appliances, and the like.

In various embodiments, the PU foam is prepared by mixing all individual components, including at least one isocyanate-reactive component which includes the novel liquid aromatic polyester polyol with at least one polyalicyclic structure, the at least one isocyanate component, and the optional components and/or auxiliary additives of component (c) such as catalyst, surfactant, blowing agents, flame retardant additives and/or any other auxiliary additives. The mixing can be carried out at room temperature or at an temperature of from 5° C. to 80° C. for a duration of from 10 ms to 20 s, followed by an immediate pouring, spraying, injection or lay down of the resulting mixture into a mold cavity or a substrate for foaming. In some embodiments, the optional components and/or auxiliary additives of component (c) such as catalysts, surfactants, blowing agent, and flame retardants, and the like, may be added to the isocyanate-reactive component or the isocyanate component prior to mixing with the other components or admixed with the other components online as separate streams.

Various methods may be used to fabricate insulation products incorporating a rigid polyurethane foam prepared from the foam-forming composition of the present invention, e.g., a continuous double belt lamination process for making insulated metal panels with a rigid metal facer (such as steel facer) on both the top and bottom surface of the panels; a continuous process for making board stock foam with flexible facers, such as aluminum foil or paper and the like, at both sides of the foam; a discontinuous process of making insulation panels or articles of three dimension shape by injecting the reactive formulation into a mold cavity followed by a subsequent curing of the formulation in the mold at a temperature in the range of from 25° C. to 80° C. for a desirable amount of time; and other processes. Skilled artisans may adapt the reaction kinetics of the present information to achieve a best mold filling and foam curing for the most economical manufacturing.

The foam-forming composition of the present invention is used to produce a rigid PU foam product having a density of from 20 kg/m³ to 200 kg/m³ in one general embodiment. In exemplary embodiments, the density of the rigid PU foams may be from 25 kg/m³ to 150 kg/m³ in one embodiment, 25 kg/m³ to 100 kg/m³ in another embodiment, 25 kg/m³ to 75 kg/m³ in still another embodiment, 25 kg/m³ to 60 kg/m³ in yet another embodiment, and 30 kg/m³ to 60 kg/m³ in even still another embodiment. Some of the advantageous properties exhibited by the resulting foam product produced according to the present invention, can include, for example: (1) lower thermal conductivity; (2) smaller cell size; (3) excellent compressive strength; and (4) good mechanical toughness such as low foam friability.

The isocyanate-reactive composition, i.e., the aromatic polyester polyol composition used in the foam-forming composition for making rigid PU foams provides a PU foam with improved thermal insulation performance. For example, the PU foam product of the present invention exhibits a low thermal conductivity of ≤20.3 mW/m-K at 10° C. in one embodiment, from 13.0 mW/m-K to 20.0 mW/m-K in another embodiment, from 14.0 mW/m-K to 19.8 mW/m-K in still another embodiment, and from 15.0 mW/m-K to 19.5 mW/m-K in yet another embodiment. The insulation performance of rigid foam as measured by thermal conductivity (or “K-factor”) is defined and determined by the procedure described in ASTM C518-17.

The PU foam of the present invention advantageously exhibits a good mechanical property, as measured in terms of compressive strength as determined by the procedure described in ASTM D1621-16. For example, in a general embodiment the PU foam exhibits a compressive strength value of ≥100 kPa. PU foams with the compressive strength <100 kPa are generally considered to lack sufficient mechanical strength for long term use.

Additionally, the PU foam of the present invention exhibits a good mechanical toughness with physical friability measured according to ASTM C421-08 of <20%. PU foams with friability >30% are generally considered to be unacceptable for most of the applications described herein. The PU foam of the present invention also advantageously exhibits a small cell size, with the average cell size of the foam being less than 170 μm in one embodiment, ≤160 μm in another embodiment, and ≤150 μm in still another embodiment.

The polyurethane foam product produced by the novel foam-forming composition and process of the present invention can be used in various types of thermal insulation applications such as for building and construction use, appliance, refrigerated transport container, cryogenic storage, and the like applications. The liquid aromatic polyester polyol of the present invention may also find use in non-foam applications such as coating, adhesive, and packaging applications.

### Examples

The following examples are presented to further illustrate the present invention in detail but are not to be construed as limiting the scope of the claims. Unless otherwise indicated, all parts and percentages are by weight.

Various materials used for the preparation of the Inventive Examples (Inv. Ex.) and of the Comparative Examples (Comp. Ex.), which follow, are explained in Table I.

TABLE I
Raw Materials

| Material | Chemical Description | Supplier |
|---|---|---|
| TYZOR AA105 | Ethoxybis(pentane-2,4-dionato- | Dorf Ketal |
| | O,O′)(propan-2-olato)titanium, | |
| | 30-60%; bis(pentane-2,4-dionato- | |
| | O,O′)bis(propan-2-olato)titanium, | |
| | 23-40%. Esterification/ | |
| | transesterification catalyst | |
| Polyethylene glycol 200 (PEG 200) | Diol, Mₙ of 200 | TCI America |
| Tricyclo[5.2.1.0^{2, 6}]decanedimethanol/ | Polyalicyclic alcohol | TCI America |
| tricyclodecanedimethanol (TCDDM) | | |
| Terephthalic acid (TA) | Aromatic dicarboxylic acid | TCI America |
| Isophthalic acid (IA) | Aromatic dicarboxylic acid | Millipore Sigma |
| Phthalic anhydride (PA) | Aromatic dicarboxylic anhydride | TCI America |
| 2,2-Bis(4-hydroxycyclohexyl) | Polyalicyclic alcohol | TCI America |
| propane (h-BPA) | | |
| 3,9-Bis(1,1-dimethyl-2- | Polyalicyclic alcohol | TCI America |
| hydroxyethyl)2,4,8,10- | | |
| tetraoxaspiro[5.5]undecane | | |
| (spiroacetal) | | |
| Isosorbide | Polyalicyclic alcohol | TCI America |
| PAPI ™ 580N | Polymeric MDI, 30.9% NCO, | Dow |
| | nominal functionality of 3 | |
| VORANATE ™ M600 | Polymeric MDI, 30.2% NCO, | Dow |
| | nominal functionality of 2.85 | |

### Example 1—Polyol Prepared with Polyalicyclic Alcohol

Into a 4-neck, 2,000 mL round bottom flask is loaded with tricyclo[5.2.1.0^{2,6}]decanedimethanol (TCDDM) (522.02 g), polyethylene glycol 200 (PEG 200)(531.89 g), and terephthalic acid (TA)(441.81 g). A nitrogen (N2) inlet adaptor with a thermocouple is inserted along with a glass stir-shaft fitted with a half-moon blade and a stir bearing with stoppers placed in the remaining necks of the flask. The flask is degassed three times by cycling between 100 Torr/13.3 kPa and atmospheric pressure of N2 via a Firestone type valve. The flask is placed under gentle N2 sweep through a Dean-Stark type trap and a condenser that are attached to the flask exit. The apparatus is completed with a heating mantle for heating the flask and the temperature of the flask is controlled by a temperature controller. The upper reactor surfaces of the flask and the Dean-Stark type trap are insulated with heat tracing and insulation. An air motor is used to drive the stir-shaft.

The flask is warmed with stirring over 2 hr to an initial setpoint of 220° C. with TYZOR AA105 (0.443 g) injected into the flask at about 80° C. as the flask warms to the setpoint. The flask is kept at 220° C. for 4.5 hr with distillate collected and drained from the Dean-Stark type trap. The flask temperature is raised and kept at 230° C. for 3.5 hr with distillate collected and drained from the Dean-Stark type trap and then the flask is cooled to 200° C. over 0.5 hr after the Dean-Stark trap and condenser are removed from the flask. The flask is stoppered under positive N2 via the Firestone type valve. To make up for excess distillate from the flask, polyethylene glycol 200 (43.0 g, 120 ppm water in PEG 200) is injected into the flask as the temperature of the flask is lowered and held at 180° C. for 1.0 hr. The flask is then slowly cooled and held at 50° C. overnight (˜12 hr) with product transferred while warm. The resulting final product has: a viscosity, 17, of 54.1 Pa-s at 25.6° C. (10 sec⁻¹); a GPC Mₙ of 584; a M_{w} of 1,004; a polydispersity index of 1.72; a hydroxyl number, OH #, of 214 mg KOH/gram; and an acid number, acid #, of <2 mg KOH/g. The detailed synthesis recipe and characterization results for the resulting product (Inv. Ex. 1) are described in Table II.

TABLE II
Aromatic Polyester Polyols Based on Polyalicyclic Alcohols

| | Example No.: | | | |
|---|---|---|---|---|
| | Inv. | Comn. | Comn. | Comn. |
| | Ex. 1 (P1) | Ex. A^{a} | Ex. B^{b} | Ex. C^{c} |
| TCDDM, g | 522.02 | — | — | — |
| h-BPA, g | — | 264.55 | — | — |
| spiroacetal, g | — | — | 31.73 | — |
| Isosorbide, g | — | — | — | 160.83 |
| PEG200, g | 531.89 | 220.10 | — | 220.10 |
| TA, g | 441.81 | 182.83 | — | 182.83 |
| PESP | — | — | 80.00 | — |
| TYZOR AA105 | 0.443 | 0.1896 | 0.0505 | 0.170 |
| PEG200, make-up, g | 43.0 | 22.7 | — | 17.0 |
| OH#, mg KOH/g | 214 | nm | nm | 281 |
| Acid#, mg KOH/g | <2 | nm | nm | <2 |
| Mₙ | 584 | nm | nm | 450 |
| M_{w} | 1,004 | nm | nm | 1,118 |
| PDI | 1.72 | nm | nm | 2.48 |
| η, Pa · s | 54.1 | wax like | wax like | 32.9 |
| | | solid | solid | |
| Tg (° C.) | −42 | −35 | −57 | −34 |

Notes for Table II:
PESP = polyester polyol prepared from PEG200 (348.33 g), terephthalic acid (193.66 g), TYZOR AA105 (0.1374 g) with Mₙ = 942, M_{w} = 1,993; and nm = NOT MEASURED or Unable to Measure.
^{a}1,000 mL round bottom flask. 4 hr @ 220° C., 4 hr to/at 230° C.
^{b}250 mL round bottom flask. Transesterification under positive N₂, 1.75 hr to 180° C., 2 hr @ 180° C., 2 hr to/at 190° C.
^{c}1,000 mL round bottom flask. 9 hr @ 220° C., 3.5 hr to/at 230° C.

### Comparative Examples A and B—Polyols Prepared with Polyalicyclic Alcohol

Following the basic synthesis protocol similar to that of P1 (Inv. Ex. 1) (with differences as noted in the footnotes of Table II) as described above except that h-BPA (Comp. Ex. A) and spiroacetal alcohol (Comp. Ex. B) was used as the polyalicyclic alcohol for the preparation of each respective polyester polyol. Interestingly, neither of these two polyester polyols is a clear liquid at room temperature. Instead, the two polyester polyols are in the form of a white paste or a white wax-like solid that do not become clear liquid below 200° C. Detailed synthesis recipes and characterization results for the resulting two polyester polyols products (Comp. Ex. A and Comp. Ex. B) are described in Table II.

### Comparative Example C—Polyol Prepared with Polyalicyclic Alcohol

A similar synthesis protocol as described in preparing P1 (Inv. Ex. 1) (with time temperature details footnoted) is followed for preparing Comp. Ex. C except that isosorbide is used as the polyalicyclic alcohol for the preparation of Comp. Ex. C. This reaction did yield a clear and transparent liquid at room temperature. The resulting final product has a viscosity, 11, of 32.9 Pa-s at 25.6° C. (10 sec⁻¹); a GPC Mₙ of 450; a M_{w} of 1,118, a polydispersity index of 2.48; a hydroxyl number, OH #, of 281 mg KOH/g; and an acid number, acid #, of <2 mg KOH/g. However, the polyol of Comp. Ex. C was not able to improve thermal insulation performance when incorporated into a foam formulation. Detailed synthesis recipe and characterization results for the resulting product (Comp. Ex. C) are described in Table II.

### Examples 2-6—Polyols Prepared with TCDDM

The polyols of Inv. Ex. 2-6 denoted as P2 to P6 respectively are prepared in a similar way to the preparation process of P1 (Inv. Ex. 1) (with differences as noted in the footnotes of Table III). Details of preparation and properties of the polyols (Inv. Ex. 2-6) are described in Table III with footnotes indicating the size of the reaction flask and the temperature profile used when setpoints are >200° C.

### Comparative Example D—Polyol Prepared with Polyalicyclic Alcohol

A similar synthesis protocol as described in the preparation of Inventive Polyol Example P6 (with differences as noted in the footnotes of Table III) is followed to prepare the polyol of Comp. Ex. D except that h-BPA is used for the preparation of Comp. Ex. D. The resulting polyester polyol is a liquid at room temperature, but the viscosity of the polyester polyol is extremely high and measured to be at 486 Pa-s. This viscosity is more than 10 times viscous in comparison to the viscosity of Inventive Polyol P6. With the very high viscosity of Comp. Ex. D, mixing of this viscous polyol with other materials is very difficult to handle and process. Detailed synthesis recipe and polyol characterization results for Comp. Ex. D are described in Table III.

TABLE III
Polyols Based on TCDDM Alcohol

| | Example No. | | | | | |
|---|---|---|---|---|---|---|
| | Inv. Ex. | Inv. Ex. | Inv. Ex. | Inv. Ex. | Inv. Ex. | Comp. Ex. |
| | 2 (P2^{a}) | 3 (P3^{b}) | 4 (P4^{C}) | 5 (P5^{d}) | 6 (P6^{e}) | D^{f} |
| TCDDM, g | 182.71 | 260.11 | 48.48 | 261.01 | 261.01 | — |
| h-BPA, g | — | — | — | — | — | 239.45 |
| PEG200, g | 347.46 | 799.05 | 444.53 | 265.94 | 267.27 | 200.21 |
| TA, g | 220.91 | 440.28 | 205.14 | — | — | — |
| IA, g | — | — | — | 220.91 | — | — |
| PA, g | — | — | — | — | 196.96 | 147.54 |
| TYZOR AA105 | 0.2157 | 0.4610 | 0.2165 | 0.2249 | 0.2237 | 0.1855 |
| PEG200, make-up, g | 26.2 | 53.1 | 30.8 | 18.2 | 10.1 | 7.4 |
| OH#, mg KOH/g | 214 | 215 | 219 | 233 | 211 | 195 |
| Acid#, mg KOH/g | <2 | <2 | <2 | <2 | <2 | 1.0 |
| Mₙ | 579 | 605 | 639 | 542 | 501 | 508 |
| M_{w} | 991 | 1027 | 1075 | 905 | 779 | 803 |
| PDI | 1.71 | 1.70 | 1.68 | 1.67 | 1.56 | 1.58 |
| η, Pa · s | 11.3 | 5.1 | 2.1 | 59.3 | 34.9 | 486 |
| Tg (° C.) | −49 | −54 | −55 | −40 | −37 | −21 |

Notes for Table III:
^{a}1,000 mL round bottom flask. 4 hr @ 220° C., 4 hr to/at 240° C.
^{b}2,000 mL round bottom flask. 3.75 hr @ 220° C., 4.5 hr to/at 240° C.
^{c}1,000 mL round bottom flask. 3.75 hr @ 220° C., 5.75 hr to/at 240° C.
^{d}1,000 mL round bottom flask. 4.67 hr @ 220° C., 3.5 hr to/at 230° C.
^{e}1,000 mL round bottom flask. 3.5 hr @ 220° C., 4 hr to/at 230° C.
^{f}1,000 mL round bottom flask. 4 hr @ 200° C., 4 hr to/at 220° C.

The results described in Table II and Table III show that TCDDM is particularly useful as a polyalicyclic alcohol for preparation of liquid aromatic polyester polyols of the present invention.

### Testing Methods Measurements of Polyols

### Viscosity

Viscosity (η) measurements on the polyols used in the Examples and Comparative Examples were carried out using a TA Instrument AR2000 rheometer with 40 mm cone at a temperature of 25.6° C. and a shear rate of 10 sec⁻¹ and using the procedure described in ISO3219.

### Hydroxyl Number

Hydroxyl number (OH #) is determined according to the procedure described in ASTM E1899-16 for the standard test method for hydroxyl groups using reaction with p-toluenesulfonyl isocyanate and potentiometric titration with a Mettler T70 titration system using tetrabutylammonium hydroxide.

### Acid Number

Acid number (acid #) is determined by the potentiometric titration of polyol (˜1 g sample size) dissolved in 25.0 mL of toluene/methanol (2/1, volume/volume) with standardized 0.01 N potassium hydroxide along with titration of a blank using a Mettler T70 titration system.

### Molecular Weight

Number average molecular weight (Mₑ), weight average molecular weight (M_{w}), and polydispersity index (PDI)=M_{w}/Mₙ)) are determined according to the procedure described in ASTM D5296-19. This method uses Gel Permeation Chromatography (GPC); an Agilent 1200 HPLC system with a PLgel Guard Column and four PLgel narrow porosity columns (5 μm, 300 mm×7.5 mm) (50 Angstrom (Å); 100 Å; 1,000 Å; and 10,000 Å); and a ReadyCal Polyethylene Glycol Calibrant Set (44000-238 Mp) utilizing uninhibited tetrahydrofuran (THF). The samples used for the molecular weight measurement were prepared at a concentration of 0.1 g/10 mL THF.

### Isocyanate-Reactive Composition and Materials for Use in Polyurethane Foam Composition

Inventive and Comparative polyols prepared in the above are used for the preparation of polyurethane foam examples.

In addition, two aromatic polyester polyols that do not contain a polyalicyclic structure, Polyol A and Polyol B, were used for the preparation of foams as well. Both Polyol A and Polyol B are prepared with the use of terephthalic acid and polyglycols such as DEG, PEG200, glycerol, and the like. Polyol A has an OH number of 220 mg KOH/g, number average molecular weight of 510 g/mol, and OH functionality of 2.0. Polyol B has an OH number of 315 mg KOH/g, number average molecular weight of 427, and OH functionality of 2.4.

Various foaming additives such as catalysts, surfactants, flame retardant (FR) additives, and physical blowing agents, and the like, were also used for making foams. For instance, DABCO® K-2097 (Catalyst A) is a trimer catalyst, available from Evonik; POLYCAT® 5 (Catalyst B) is a blowing catalyst, available from Evonik; Surfactant A is TEGOSTAB® B8421, a silicone polyether surfactant commercially available from Evonik; Surfactant B is a silicone polyether surfactant, available from Dow; and TEP (FR Additive) is triethyl phosphate flame retardant, available from ICL-IP.

The physical blowing agent used in the foam Examples and Comparative Examples is a 70/30 blend of cyclopentane and iso-pentane, c/i-pentane blend (70/30).

### Foam Preparation

Two different methods are used for foam preparation: (1) hand mixing with an overhead mixer and (2) high pressure machine run with an impingement mixer. Several polyester polyols were prepared at kg quantities to allow foam preparation with a high-pressure machine. The above two methods are denoted herein as hand mixing (HM) and high pressure machine (HP) runs.

### General Protocol for Hand Mixing Foam Preparation:

Polyol, surfactant, flame retardant, catalyst and water were added into a 1,000 mL plastic cup and the plastic cup with its contents was weighed. Then, the cup contents were mixed with an overhead mixer to provide a “polyol mixture” (B-Side). A targeted amount of blowing agent was then added into the cup and thoroughly mixed with the polyol package. Subsequently, a desired amount of a polyisocyanate component (A-side) was added into the formulation mixture in the cup. The resultant formulation was immediately mixed with a high-speed overhead mixer at a mixer-speed of 3,000 rpm for 5 s and then the mixed formulation was poured into a preheated mold which was preheated to 55° C. The size of the mold was 30 cm (Height)×20 cm (Length)×5 cm (Thickness). The mold was placed vertically along the mold's “Height” direction for foaming. The foam was removed from the mold after about 20 min and placed on a lab bench overnight prior to conducting physical properties testing on the resulting foam product.

### General Protocol for HP Machine Foam Preparation

Proper amounts of polyol, surfactant, flame retardant, catalyst, physical blowing agent and water were weighed and added into a 5-gallon [19-Liter] plastic bucket, followed by a thorough mixing with an air mixer. The resultant formulation denoted as the “polyol mixture” (B-Side) was then loaded into the polyol tank of a foaming machine, a Cannon A40 High Pressure (HP) foaming machine. Polyisocyanate such as VORANATE™ M 600 denoted as the “A-side” is loaded into the iso tank of the Cannon A40 HP machine. A foam formulation consisting of a proper amount of the A-side and B-side were mixed together by an impingement mixer and immediately introduced into the mold cavity where the components were allowed to react and expand. The pump pressure of both the isocyanate and polyol pump streams were at 1,500 psi (10,342 kPa) and the temperature of both the polyol and isocyanate streams were set at 70° F. (21° C.).

A flat plate mold was used for foam preparation by HP machine runs. The flat plate mold has dimensions of 30 cm (Length)×30 cm (Width)×10 cm (Thickness or Height). The “Thickness or Height” direction of this mold corresponds to the foam rise direction during the foam preparation. The flat plate mold is pre-heated to 55° C. and kept constant at 55° C. for the entire duration of foam preparation. The reactive foaming mixture was injected into the mold and cured inside the mold for 5 min before removing the foam sample out of the mold. All foams made by HP machine runs were placed on a lab bench overnight prior to conducting physical properties testing.

### Test Methods and Measurements of Foam Properties

Various tests were performed on the foam products made in accordance with the Examples and Comparative Examples described herein.

### Cream Time, Gel Time, Tack Free Time

Cream time, gel time, and tack free time are determined according to the testing procedure described in ASTM D7487 (2013). The general procedure for the cream time and gel time measurements includes the following: A free rise foam is made by the plastic cup method described in the above ASTM procedure. Using this method, polyols, surfactant, flame retardants, catalysts, and water are weighed into a plastic cup. An overhead mixer at from 200 rpm to 500 rpm is used to thoroughly mix the polyol components. A proper amount of blowing agent is then and added into the cup and thoroughly mixed into the polyol side components. Isocyanate components are then added into the cup followed by immediate mixing using an overhead mixer at about 3,000 rpm for 5 s. The recording of time begins when the mixing of isocyanate and the polyol side mixture is triggered. When the foam formulation in the cup shows a distinct color or appearance change due to the formation of large number of bubbles or more commonly known as creaming by skilled artisans, the time is recorded as “Cream Time”. The tip of a wood tongue depressor is then dipped into the foam formulation and quickly pulled out to check whether the foaming mixture becomes stringy. The time when the foaming formulation becomes stringy based on the wood tongue depressor testing is recorded as “Gel Time”. The time when the top surface of the foam is not sticky when lightly tapping a wood tongue depressor on the foam top surface is recorded as “tack-free time”. The “tack-free time” is reached when lifting the wood tongue depressor does not lead to indentation or rupture of the foam surface.

### Thermal Conductivity (K-Factor or Lambda Value)

Within 24 hr after the foams were made (and after an overnight sitting on a lab bench), foam specimens at a size of 20 cm×20 cm×2.5 cm were cut from the middle interior section of the molded foams for thermal conductivity measurements. Measurements were conducted at 50° F. (10° C.) according to the procedure described in ASTM C518-17. The average of K-factor measurements over at least two testing specimens for each Example and Comparative Example was reported.

### Foam Core Density

The density of rigid foam was measured according to the procedure described in ASTM 1622-03 (2008). Cubic specimens having a size of 5 cm×5 cm×5 cm were cut out from the middle interior section of the molded foams for measurement. The density of each specimen was calculated by weighing the mass and measuring their exact dimensions. Measurement on at least three specimens for each foam sample was conducted, and their average values were reported.

### Free Rise Density

Free rise density on foams made by high pressure machine runs was also measured. The reactive foaming mixture at a pre-determined amount was injected into an open wooden box of 20 cm×20 cm×20 cm with a plastic liner. The foaming mixture was allowed to react, expand and cure inside of this open wooden box at room temperature for about 2 hr. A rectangular block of foam sample at approximate size of 14 cm×12 cm×10 cm was then cut for weighing the mass and determining their exact dimensions for density calculation. Measurement of three free rise foams from each foam formulation was conducted, and their average values were reported.

### Compressive Strength

Compressive strength (CS) of the foam samples measures the mechanical resistance of the foams to compression stress. Measurements are made on the direction parallel to the foam rise direction (z-axis) and/or perpendicular to foam rise direction (x-axis). Testing was performed according to ASTM D1621 method on 5 cm×5 cm×2.5 cm foam specimens taken from the middle interior section of the mold foams.

### Physical Friability

The physical friability property of the foams was measured by testing foam specimens in a tumbling machine according to the procedure described in ASTM C421-08. The apparatus includes a cubical box of oak wood, having inside dimensions of 7½ inches by 7¾ inches by 7¾ inches (190 mm by 197 mm by 197 mm). The box shaft was motor driven at a constant speed of 60 rpm. Twenty-four room-dry, solid oak, ¾ inches (19 mm) cubes were placed in the box with the test specimens. The test specimens were prepared by cutting the interior parts of the molded foams with a fine-tooth saw into 1 inch (25.4 mm) cubes.

### Foam Cell Size

Cell size analysis was measured on several foams by analyzing a foam sample of 2 cm×1 cm×0.5 cm with the Porescan® system. PoreScan® is an automated cell size analysis instrument made by Goldlucke Ingenieurleistungen. The system includes a camera and a software component. A contrast liquid (provided by Goldlucke Ingenieurleistungen) is deposited on the foam sample through spray coating and it is composed by carbon black in pentane with propane and butane as propellants. The foam sample treated with the contrast agent is imaged by the camera and processed through the software. For each sample at least 5000 cells were imaged and analyzed.

### Foam Prepared by Hand Mixing

### Comparative Example E—Foam F-A

180 grams of foaming mixture were prepared in accordance with the “General Protocol for Hand Mixing Foam Preparation”; and then the mixture was immediately poured into a vertically standing mold of 5 cm×20 cm×30 cm. About 135 g of foaming mixture were poured inside of the mold. The foam was removed from the mold after 20 min and placed on a lab bench overnight prior to conducting physical properties testing on the resulting foam product. Foam properties characterization results were summarized in Table IV.

### Examples 7-15—Foams F-1 to F-9

Replicate the protocol of Comp. Ex. Foam F-A by substituting part of Polyol A in Comp. Ex. F-A with one of the inventive polyester polyols synthesized from TCDDM at each respective amount shown in Table IV. Foam properties for F-1 to F-9 were measured and are described in Table IV.

TABLE IV
Foam Formulation Comprising Various TCDD Polyols

| | Example No. | | | | | | | | | |
|---|---|---|---|---|---|---|---|---|---|---|
| | Comp. Ex. | Inv. Ex. | Inv. Ex. | Inv. Ex. | Inv. Ex. | Inv. Ex. | Inv. Ex. | Inv. Ex. | Inv. Ex. | Inv. Ex. |
| | E [F-A] | 7 [F-1] | 8 [F-2] | 9 [F-3] | 10 [F-4] | 11 [F-5] | 12 [F-6] | 13 [F-7] | 14 [F-8] | 15 [F-9] |
| | (pts) | (pts) | (pts) | (pts) | (pts) | (pts) | (pts) | (pts) | (pts) | (pts) |
| Components | | | | | | | | | | |
| Polyol A | 75 | 25 | 50 | 25 | | 25 | 50 | 25 | 50 | 50 |
| Polyol B | 25 | 25 | 25 | 25 | 25 | 25 | 25 | 25 | 25 | 25 |
| Polyol P1 | | 50 | 25 | | | | | | | |
| Polyol P2 | | | | 50 | | | | | | |
| Polyol P3 | | | | | 75 | 50 | 25 | | | |
| Polyol P4 | | | | | | | | 50 | | |
| Polyol P5 | | | | | | | | | 25 | |
| Polyol P6 | | | | | | | | | | 25 |
| TEP | 18.5 | 18.5 | 18.5 | 18.5 | 18.5 | 18.5 | 18.5 | 18.5 | 18.5 | 18.5 |
| DABCO ® K-2097 | 2.22 | 2.22 | 2.22 | 2.22 | 2.22 | 2.22 | 2.22 | 2.22 | 2.22 | 2.22 |
| POLYCAT 5 | 1.17 | 1.17 | 1.17 | 1.17 | 1.17 | 1.17 | 1.17 | 1.17 | 1.17 | 1.17 |
| Silicone Surfactant A | 3.7 | 3.7 | 3.7 | 3.7 | 3.7 | 3.7 | 3.7 | 3.7 | 3.7 | 3.7 |
| c/i-pentane blend (70/30) | 21 | 21 | 21 | 21 | 21 | 21 | 21 | 21 | 21 | 21 |
| Water | 1 | 1 | 1 | 1 | 1 | 1 | 1 | 1 | 1 | 1 |
| Total from B-side | 147.6 | 147.6 | 147.6 | 147.6 | 147.6 | 147.6 | 147.6 | 147.6 | 147.6 | 147.6 |
| PAPI ™ 580N (A-side) | 307.9 | 307.9 | 307.9 | 307.9 | 307.9 | 307.9 | 307.9 | 307.9 | 307.9 | 307.9 |
| Properties | | | | | | | | | | |
| Cream Time (s) | 10 | 10 | 10 | 11 | 10 | 10 | 10 | 10 | 10 | 10 |
| Gel Time (s) | 31 | 31 | 31 | 30 | 29 | 30 | 30 | 29 | 30 | 29 |
| Tack Free Time (s) | 100 | 100 | 110 | 85 | 105 | 105 | 100 | 105 | 95 | 100 |
| Foam Density (kg/m³) | 42.4 | 43.4 | 42.7 | 41.6 | 43 | 42 | 42.2 | 42.8 | 42.6 | 43 |
| K-Factor at 50° F. | 20.75 | 19.8 | 19.25 | 18.94 | 19.62 | 19.62 | 20.27 | 20.3 | 19.55 | 19.91 |
| (10° C.) (mW/m-K) | | | | | | | | | | |
| CS in x-axis (kPa) | 137.2 | 142.7 | 139.3 | 143.1 | 141.3 | 135.2 | 129.7 | 129.1 | 123.5 | 136.9 |

The results described in Table IV show that thermal conductivity or K-factor measured on foams prepared from formulations comprising the liquid aromatic polyester polyol of the present invention are considerably lower than that of the Comp. Ex. E (F-A). There is no measurable difference in foam reaction kinetics between the inventive foam formulations and the reference formulation. No deterioration on foam mechanical properties were observed for all the foams of Inv. Ex. 7-15.

### Foam Prepared by High Pressure Machine Run

### Example 16 (Foam F-10) and Comparative Example G (Foam F-B)

These examples are prepared from the respective formulations shown in Table V by a high pressure foaming machine equipped with an impingement mixer (Model: Cannon A40). Comp. Ex. F-B and F-10 differ only on the types of aromatic polyester polyols used in that F-10 used 50 pts of P1 (Inv. Ex. 1) per 100 pts of total polyols, whereas Comp. Ex F-B only used aromatic polyester polyols that do not contain a polyalicyclic structure. A flat plate mold having the dimension of 30 cm (Length)×30 cm (Width)×10 cm (Height) is used for molding foams. This mold was pre-heated to 55° C. and kept constant at 55° C. for foam curing. Foams prepared in this mold were removed out of the mold after 5 min curing. Detailed properties for Comp. Ex. F-B and F-10 are reported in Table V.

Results in Table V show that foams prepares from the inventive polyol P1 (Inv. Ex. 1) give excellent foam properties over the comparative foam example: lower thermal conductivity, smaller cell size, similar mechanical properties in terms of compressive strength and physical friability.

TABLE V
Foams made by HP Machine Run with TCDD50-TA Polyol

| | Example No. | |
|---|---|---|
| | Comp. Ex. G | Inv. Ex. 16 |
| | [F-B] (Pts) | [F-10] (pts) |
| Composition | | |
| Polyol A | 75 | 25 |
| Polyol B | 25 | 25 |
| Polyol P1 | — | 50 |
| TEP | 18.5 | 18.5 |
| DABCO ® K-2097 | 2.22 | 2.22 |
| POLYCAT 5 | 1.17 | 1.17 |
| Silicone Polyether Surfactant B | 3.7 | 3.7 |
| c/i-pentane blend (70/30) | 21 | 21 |
| Water | 1 | 1 |
| Total from B-side | 147.6 | 147.6 |
| VORANATE ™ M600 (A-side) | 307.9 | 307.9 |
| Properties | | |
| Cream Time (s) | 3 | 3 |
| Gel Time (s) | 19 | 19 |
| Tack Free Time (s) | 29 | 32 |
| Free Rise Density (kg/m³) | 34.5 | 34.8 |
| Foam Core Density (kg/m³) | 40 | 40 |
| K-factor at 50° F. (10° C.) (mW/m-K) | 20.4 | 19.6 |
| Compressive Strength in z- axis (kPa) | 254.6 | 255.8 |
| Compressive Strength in x- axis (kPa) | 146 | 130.2 |
| Physical Friability (%) | 16.6 | 15.3 |
| Average Foam Cell Size (μm) | 170 | 138 |

Taking together, the results described in Table IV and Table V, show clearly that the novel liquid aromatic polyester polyol of the present invention is surprisingly and uniquely advantageous for use in a polyurethane foam formulation to achieve a lower thermal conductivity and smaller cell size than the Comparative Example foam while still maintaining excellent mechanical strength, foam toughness, and the like properties.

1. A liquid aromatic polyester polyol composition comprising at least one polyalicyclic structure having the following general chemical Structure (I): 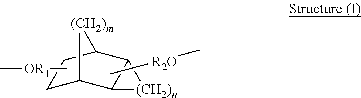
wherein m is an integer number equal to 1 or 2; n is an integer number equal to 0, 1, 2, 3, or 4; R₁ and R₂ are each independently a divalent hydrocarbon group selected from 1 to 6 carbon atoms; and wherein when n is greater than or equal to 1, R₂ is bonded to the ring with (CH₂)ₙ; wherein the aromatic polyester polyol composition is a clear liquid at room temperature; wherein the viscosity of the aromatic polyester polyol composition, at room temperature and at a shear rate of 10 sec⁻¹, is no greater than 100 Pa-s; and wherein the OH number of the aromatic polyester polyol composition is in the range of from 100 mg KOH/g to 500 mg KOH/g.

2. The aromatic polyester polyol composition of claim 1 comprising a reaction product of:
(i) at least one compound selected from the group consisting of: an aromatic dicarboxylic acid, an aromatic dicarboxylic anhydride, an aromatic tricarboxylic acid, an aromatic tricarboxylic anhydride, an aromatic tetracarboxylic acid, an aromatic tetracarboxylic anhydride, and an aromatic carboxylic acid source; wherein the total amount of carboxylic acid group and/or carboxylic acid equivalent group that are directly bonded to an aromatic ring structure in compound (i) is at least 25 mol %, based on the total moles of carboxylic acid group and carboxylic acid equivalent group used in the preparation of the aromatic polyester polyol; and
(ii) at least one polyhydric alcohol; wherein the at least one polyhydric alcohol comprises a polyalicyclic ring of Structure (I) and/or a compound having the following general chemical Structure (II): 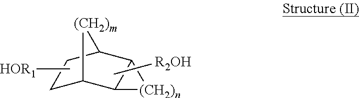
wherein m is an integer number equal to 1 or 2; n is an integer number equal to 0, 1, 2, 3, or 4; R₁ and R₂ are each independently a divalent hydrocarbon group selected from 1 to 6 carbon atoms; and wherein when n is greater than or equal to 1, R₂ is bonded to the ring with (CH₂)ₙ; and wherein the amount of the at least one polyhydric alcohol having the polyalicyclic ring of Structure (I) and/or Structure (II) is at least 10 percent based on the total moles of hydroxyl groups of all polyhydric alcohols used in the preparation of the aromatic polyester polyol; wherein the aromatic polyester polyol composition is a clear liquid at room temperature; wherein the viscosity of the aromatic polyester polyol composition, at room temperature and at a shear rate of 10 sec⁻¹, is no greater than 100 Pa-s; and wherein the OH number of the aromatic polyester polyol composition is in the range of from 100 mg KOH/g to 500 mg KOH/g.

3. The polyester polyol composition of claim 2, wherein component (ii) is tricyclodecanedimethanol; isomers of tricyclodecanedimethanol; and mixtures thereof.

4. A process for producing a polyester polyol composition comprising reacting:
(i) at least one compound selected from the group consisting of: an aromatic dicarboxylic acid, an aromatic dicarboxylic anhydride, an aromatic tricarboxylic acid, an aromatic tricarboxylic anhydride, an aromatic tetracarboxylic acid, an aromatic tetracarboxylic anhydride and an aromatic carboxylic acid source; wherein the total amount of carboxylic acid group and/or carboxylic acid equivalent group that are directly bonded to an aromatic ring structure in compound (i) is at least 25 mol % based on the total moles of carboxylic acid group and carboxylic acid equivalent group used in the preparation of the aromatic polyester polyol; and
(ii) at least one polyhydric alcohol; wherein the at least one polyhydric alcohol comprises a polyalicyclic ring of Structure (I) and/or a compound having the following general chemical Structure (II): 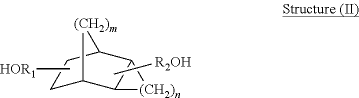
wherein m is an integer number equal to 1 or 2; n is an integer number equal to 0, 1, 2, 3, or 4; R₁ and R₂ are each independently a divalent hydrocarbon group selected from 1 to 6 carbon atoms; and wherein when n is greater than or equal to 1, R₂ is bonded to the ring with (CH₂)ₙ; and wherein the amount of the at least one polyhydric alcohol having the polyalicyclic ring of Structure (I) and/or Structure (II) is at least 10 percent based on the total moles of hydroxyl groups of all polyhydric alcohols used in the preparation of the aromatic polyester polyol; wherein the aromatic polyester polyol composition is a clear liquid at room temperature; wherein the viscosity of the aromatic polyester polyol composition, at room temperature and at a shear rate of 10 sec⁻¹, is no greater than 100 Pa-s; and wherein the OH number of the aromatic polyester polyol composition is in the range of from 100 mg KOH/g to 500 mg KOH/g.

5. An isocyanate-reactive composition including the aromatic polyester polyol composition of claim 1.

6. The isocyanate-reactive composition of claim 5, further including at least one other polyol different from the aromatic polyester polyol having the polyalicyclic structure, and wherein such other polyol is selected from a polyester polyol; a polyether polyol; a polycarbonate polyol; or mixtures thereof; wherein the amount of the aromatic polyester polyol having the polyalicyclic structure is at least 10 parts, based on the total amount of polyols in the isocyanate reactive composition equal to 100 parts.

7. A foam-forming composition comprising a reactive mixture of:
(a) at least one isocyanate component; and
(b) at least one isocyanate-reactive component; wherein the at least one isocyanate-reactive component comprises the isocyanate-reactive composition of claim 5; and wherein the isocyanate index of the foam-forming composition is from 100 to 600.

8. A process for producing a foam-forming composition comprising reacting:
(a) at least one isocyanate component; and
(b) at least one isocyanate-reactive component; wherein the at least one isocyanate-reactive component comprises the isocyanate-reactive composition of claim 5.

9. A polyurethane or polyisocyanurate foam product comprising the reaction product of:
(I) at least one isocyanate component with an isocyanate index of from 100 to 600; and
(II) the isocyanate-reactive composition of claim 5.

10. The polyurethane or polyisocyanurate foam product of claim 9, wherein the thermal conductivity (K-factor or Lambda value) of the polyurethane product, as measured according to the procedure described in ASTM C518-17 at 10° C., is less than or equal to 20.3 mW/m-K.
